(19) United States
(12) Patent Application Publication
(10) Pub. No.: US 2026/0062601 A1
(43) Pub. Date: Mar. 5, 2026

(54) METHOD OF USING GRAPHITE OR GRAPHENE IN SPACER FLUID FOR DISPLACING NON-AQUEOUS DRILLING FLUID

(71) Applicant: Baker Hughes Oilfield Operations LLC, Houston, TX (US)

(72) Inventors: Angela Anh Doan, Spring, TX (US); Radhika Suresh, Sugar Land, TX (US); Violeta Ramos-Edwards, Houston, TX (US)

(21) Appl. No.: 18/816,631

(22) Filed: Aug. 27, 2024

(51) Int. Cl. C09K 8/40

(52) U.S. Cl. CPC C09K 8/40; C09K 2208/10

(57) ABSTRACT

A method includes injecting a spacer fluid into a wellbore that contains a non-aqueous drilling fluid, the spacer fluid including a liquid carrier and carbon particles which includes at least one of a graphite or graphene; and displacing the drilling fluid with the spacer fluid.

### BACKGROUND

Drilling fluids (or “muds”) used in the drilling of subterranean oil and gas wells and other drilling applications are well known. Drilling fluids carry cuttings and other particulates from beneath the bit, transport them through the annulus, and allow their separation at the surface while at the same time the rotary bit is cooled and cleaned. Drilling fluids are also intended to reduce friction between the drill string and the sides of the hole while maintaining the stability of uncased sections of the borehole. Drilling fluids can also be formulated to prevent unwanted influxes of formation fluids from permeable rocks penetrated.

A spacer fluid, in contrast, is a liquid used to physically separate one special-purpose liquid from another. A cement spacer fluid separates a drilling fluid from a cement slurry during cementing operations in a wellbore. A cement spacer fluid can also clean up the wellbore. Prior art cement spacer fluids include microemulsions that contain various surfactants. While these emulsions can displace drilling muds from the wellbore, some microemulsions have certain drawbacks, for example, instability under operating conditions, especially at the higher temperatures that can exist at the bottom of a wellbore. Certain surfactants'ability to clean the wellbore can also decrease at higher wellbore temperatures. These disadvantages can affect the quality of the cementing operation in the drill hole, for example, by failing to adequately remove the drilling fluid, the performance of the set cement slurry may be compromised with respect to its ability to bond to both the exposed rock surface in the drilled wellbore and to the tubulars placed in the wellbore. Accordingly, there remains a need in the art for improved spacer fluids that overcome aforementioned drawbacks. In particular, a need remains for a spacer fluid that can effectively remove particulates such as drilling muds, as well as liquid contaminant from the wellbore.

### SUMMARY

A method includes injecting a spacer fluid into a wellbore that contains a non-aqueous drilling fluid, the spacer fluid including a liquid carrier and carbon particles containing at least one of a graphite or graphene; and displacing the drilling fluid with the spacer fluid.

A spacer fluid includes: an aqueous carrier; about 0.1 pound per barrel to about 10 pounds per barrel of graphite nanoplates, graphene nanoplatelets, or a combination thereof; about 0.1 pound per barrel to about 5 pounds per barrel of a gelling agent, the gelling agent containing at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay; about 100 pounds per barrel to about 600 pounds per barrel of a weighting agent, the weighting agent including at least one of barium sulfate, silica flour, fly ash, calcium carbonate, hematite, ilmenite, or siderite, and about 0 gallon per barrel to about 10 gallons per barrel of a surfactant.

### BRIEF DESCRIPTION OF THE DRAWINGS

FIG. 1A is a picture of a rotary sleeve before a rotor test, FIG. 1B is a picture of the rotary sleeve of FIG. 1A after it is exposed to a non-aqueous drilling fluid, and FIG. 1C is a picture of the rotary sleeve of FIG. 1B after the drilling fluid coated rotary sleeve is treated with a baseline spacer fluid; and

FIG. 2A is a picture of a rotary sleeve before a rotor test, FIG. 2B is a picture of the rotary sleeve of FIG. 2A after it is exposed to a non-aqueous drilling fluid, and FIG. 2C is a picture of the rotary sleeve of FIG. 2B after the drilling fluid coated rotary sleeve is treated with a spacer fluid according to the disclosure.

### DETAILED DESCRIPTION

The inventors have found that using graphite and/or graphene in a spacer fluid with reduced surfactant content or without surfactants can provide a spacer fluid that is stable at high temperatures. Unlike the current spacers based on microemulsions, the instant spacer fluid can be used at higher temperatures, and effectively displace non-aqueous drilling fluids.

The method comprises injecting a spacer fluid into a wellbore that comprises a non-aqueous drilling fluid, and displacing the non-aqueous drilling fluid with the spacer fluid, wherein the spacer fluid comprises an aqueous carrier and carbon particles which comprise at least one of a graphite or graphene.

As used herein, graphite includes at least one of natural graphite; synthetic graphite; expandable graphite; or expanded graphite. Natural graphite is graphite formed by Nature. Synthetic graphite is a manufactured product made from carbon materials. Pyrolytic graphite is one form of the synthetic graphite. Expandable graphite refers to graphite having intercallant materials inserted between layers of natural graphite or synthetic graphite. A wide variety of chemicals have been used to intercalate graphite materials. These include acids, oxidants, halides, or the like. Exemplary intercallant materials include sulfuric acid, nitric acid, chromic acid, boric acid, SO₃, or halides such as FeCl₃, ZnCl₂, and SbCl₅. Upon heating, the intercallant is converted from a liquid or solid state to a gas phase. Gas formation generates pressure which pushes adjacent carbon layers apart resulting in expanded graphite.

Preferably, the graphite comprises graphite nanoplates (GNPs). GNPs are thin particles having a platelet morphology with a thickness of greater than 0 nanometers (nm) to about 40 nm, preferably about 10 nm to about 40 nm, and more preferably about 20 nm to about 40 nm. The GNPs can have an average width of about 400 nm to about 1200 nm.

Graphene can also include graphene nanoplatelets. The graphene nanoplatelets have a stacked structure of one or more layers of fused hexagonal rings with an extended delocalized π-electron system, layered and weakly bonded to one another through π-π stacking interaction. The graphene nanoplatelets have fewer than 10 single sheet layers, specifically fewer than 8 single sheet layers, more specifically about 3 to about 6 single sheet layers. The graphene nanoplatelets can have a thickness of about 1 nm to about 10 nm or about 2 nm to about 8 nm.

The graphene nanoplatelets can have a largest surface area of about 500 to about 2,000 square meters per gram (m²/g), preferably about 800 to about 1,500 m²/g, more preferably about 800 to about 1,200 m²/g.

The graphene nanoplatelets can have a carbon purity of greater than greater than 80%, greater than 85%, greater than 90%, greater than 95%, greater than 98%, or greater than 99%, and preferably greater than 99.5%. Preferably, the graphene nanoplatelets do not contain graphene oxide, and the graphene nanoplatelets are not functionalized with any functional group.

A content of the carbon particles in the spacer fluid can be about 0.05 pound per barrel (ppb) to about 10 ppb, about 0.5 ppb to about 5 ppb, or about 0.5 ppb to about 2 ppb.

The aqueous carrier can be fresh water, or a brine. The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from an underground reservoir source of fresh water or brackish water. Produced water can also be referred to as reservoir brine and contain components including barium, strontium, and heavy metals. In addition to naturally occurring brines (e.g., seawater and produced water), completion brine can be synthesized from fresh water by addition of various salts for example, KCl, NaCl, ZnCl₂, MgCl₂, or CaCl₂ to increase the density of the brine. The above brines can be modified to include one or more additional salts. The additional salts included in the brine can be at least one of NaCl, KCl, NaBr, MgCl₂, CaCl₂, CaBr₂, ZnBr₂, NH₄Cl, sodium formate, or cesium formate.

The aqueous carrier can be present in the spacer fluid in an amount of about 10% to about 98% by weight, more preferably in an amount of about 20% to about 98% by weight, or 60% to 98 wt% based on the total weight of the spacer fluid.

The spacer fluid can further include at least one of a weighting agent, a gelling agent, or a surfactant. The gelling agent can include at least one of natural polymers such as guar gums, guar derivatives such as hydropropyl guar (HPG), carboxymethyl guar (CMG), and carboxymethylhydroxypropyl guar (CMHPG), high-molecular weight, hydratable polysaccharides, xanthan gum (which can optionally be crosslinked), galactomannan gums, glucomannan gums, cellulose, cellulose derivatives such as hydroxyethylcellulose (HEC), carboxymethylcellulose (CMC), hydroxypropylcellulose (HPC), and carboxymethylhydroxyethylcellulose (CMHEC); synthetic polymers such as poly((meth)acrylic acid)s, poly((meth)acrylamides), copolymers of (meth)acrylic acid and (meth)acrylamide, and C1-8 alkyl poly(meth)acrylates; or clays such as bentonite, sepiolite, and attapulgite, and the like.

A content of the gelling agent can be about 0.1 pound per barrel (ppb) to about 10 ppb, about 0.5 ppb to about 5 ppb, or about 0.5 ppb to about 2 ppb.

The weighting agent is a high-specific gravity and finely divided solid material used to increase density. The weighting agent in the spacer fluid can include at least one of barium sulfate, silica flour, fly ash, calcium carbonate, hematite, ilmenite, or siderite.

A content of the weighting agent can be about 0 to about 600 ppb, greater than 0 to about 600 ppb, about 50 ppb to about 600 ppb, about 100 ppb to about 500 ppb, or about 200 ppb to about 400 ppb.

Surfactants can increase the compatibility of the spacer fluid and the drilling fluid and/or cement slurry. The surfactant can be anionic, cationic, zwitterionic, or non-ionic. Other useful surfactants include those having poly(alkylene glycol) side chains, fatty acids, or fluorinated groups such as perfluorinated C₁₋₄ sulfonic acids grafted to the polymer backbone. Polymer backbones include those based on a polyester, a poly(meth)acrylate, a polystyrene, a poly(styrene-(meth)acrylate), a polycarbonate, a polyamide, a polyimide, a polyurethane, a polyvinyl alcohol, or a copolymer comprising at least one of these polymeric backbones.

A content of the surfactant in the spacer fluid can be about 0 gallon per barrel (gpb) to about 10 gpb, greater than 0 gpb to about 10 gpb, about 0.01 gpb to about 10 gpb, about 0.05 gpb to about 5 gpb, or about 0.5 gpb to about 2 gpb.

The spacer fluid can comprise other components known for use in spacer fluids, for example a pH control agent, a lubricant, a fluid loss agent, a clay stabilizer, a biocide, a corrosion inhibitor, a friction reducer, an oxygen scavenger, a formation fines controller, a foamer, a gel stabilizer, a crosslinker, or a combination thereof. These additional components are selected so as to avoid imparting unfavorable characteristics to the spacer fluids, to avoid damage to equipment in contact with the spacer fluids, and to avoid damaging the wellbore or subterranean formation. Each additive can be present in amounts generally known to those of skill in the art.

The pH-adjusting agent can be an organic or inorganic base, organic or inorganic acid, or a buffer, which is any appropriate combination of acid and conjugate base. Examples of inorganic bases include those represented by MOH, where M is a metal from group 1 or 2 of the periodic table, a transition metal, or a metal or metalloid from group 13, 14, or 15; carbonate salt; and bicarbonate salt. Examples of inorganic acids include HCl, HBr, fluoroboric acid, sulfuric acid, nitric acid, acetic acid, formic acid, methanesulfonic acid, propionic acid, chloroacetic or dichloroacetic acid, citric acid, glycolic acid, or lactic acid. More than one pH-adjusting agent can be used.

Lubricants minimize friction and can include materials such as a polyacrylamide, petroleum distillate, hydrotreated light petroleum distillate, a short chain alcohol (e.g., methanol), or polyol (e.g., ethylene glycol or glycerol), polyisobutyl methacrylate, polymethyl methacrylate, polyisobutylene, guar, guar derivatives, a polysaccharide such as cellulose and starch, and polyethylene oxide. More than one lubricants can be used.

Fluid-loss control agents are usually water-soluble polymers such as guar gums, polyethyleneimine, cellulose derivatives, and polystyrene sulfonate. Some polymers can function as both a gelling agent and a fluid-loss control agent.

Biocides prevent injection of a microbe (e.g., bacteria) downhole by eliminating or reducing bacteria in the spacer fluid, thus reducing production of, e.g., sour gas. Optionally, the biocide is encapsulated or coated.

A crosslinker for the gelling agent can be present, for example a borate, titanate, zirconate, aluminate, or chromate crosslinker. The spacer fluid can include more than one crosslinker.

The various properties of the spacer fluids can be varied and adjusted according to well control and compatibility parameters of the particular drilling fluid, cement slurry, or other fluid being segregated. For example, the viscosity of the spacer fluid can vary over a wide range, and spacer fluid can have an apparent viscosity (AV) of about 0.9 to about 200 centiPoise (cP).

The density of the spacer fluid can also vary over a wide range but preferably, the spacer fluid is heavier (denser) than the preceding fluid (drilling fluid), and lighter than the following fluid (e.g., a 12 ppg drilling fluid and then a 14 ppg spacer fluid and then a 16 ppg cement slurry). The spacer fluid can have a density that is about 2 ppg higher than a density of the drilling fluid. The spacer fluid can also have a yield point that is about 1.5 times higher than a yield point of the drilling fluid.

As specific examples, the spacer fluid comprises, consists essentially of, or consists of about 0.1 gpb to about 5 gpb, about 0.1 gpb to about 3 gpb, about 0.1 gpb to about 2 gpb, or about 0.1 to about 1.5 gpb of graphite nanoplates, graphene nanoplatelets, or a combination thereof as carbon particles; about 0.1 ppb to about 5 ppb, about 0.1 ppb to about 2 ppb, or about 0.1 ppb to about 1.5 ppb of a gelling agent; about 0 to about 600 ppb, about 50 ppb to about 600 ppb, about 100 ppb to about 500 ppb, or about 200 ppb to about 400 ppb of a weighting agent, the weighting agent comprising at least one of barium sulfate, silica flour, fly ash, calcium carbonate, hematite, ilmenite, or siderite; and about 0 gpb to about 10 gpb, about 0.05 gpb to about 5 gpb, about 0.5 gpb to about 2 gpb, or about 0.5 to about 1.5 gpb of a surfactant, and optionally an additive comprising at least one of a pH control agent, a lubricant, a fluid loss agent, a clay stabilizer, a biocide, a corrosion inhibitor, a friction reducer, an oxygen scavenger, a formation fines controller, a foamer, a gel stabilizer, or a crosslinker. A content of the additive, if present, can be greater than 0 to about 2 gpb, about 0.05 gpb to about 2 gpb, about 0.1 gpb to about 1.5 gpb, or about 0.5 gpb to about 1 gpb.

The spacer fluid can be premixed or is injected without mixing, e.g., injected “on the fly” where the components are combined as the spacer fluid is being injected downhole. The order of addition can be varied and the time of injecting each is the same or different.

The spacer fluid as describe herein can displace a non-aqueous drilling fluid, and preferably to further remove oil and solids from the well and wellbore surfaces. Thus displacing the drilling fluid also includes displacing a contaminant particulate present in the wellbore. The contaminant particulate comprises at least one of a drilling fluid particulate, drilling cutting, or a reservoir rock particulate such as a shale particulate, mudstone particulate, sandstone particulate, or carbonate particulate.

As used herein, the non-aqueous drilling fluid is an oil-based drilling fluid. In oil based drilling fluids, solid particles are suspended in oil, and water or brine may be emulsified with the oil. The oil is typically the continuous phase or external. Water or brine is the discontinuous or internal phase. The oil phase may include at least one of a diesel oil, a paraffin oil, a vegetable oil, a soybean oil, a mineral oil, a crude oil, a gas oil, kerosene, an aliphatic solvent, an aromatic solvent, or a synthetic oil. The oil based drilling fluid can also comprise an emulsifier such as various fatty acid and derivatives thereof, and polymers such as polyamides. Exemplary fatty acid derivatives include fatty acid soaps, such as the calcium soaps, which can be prepared by reacting a fatty acid with lime.

In a cementing operation, after the non-aqueous drilling fluid is displaced by the spacer fluid, a cement slurry is then injected into the wellbore (optionally with a “lead slurry” or a “tail slurry”). The cement slurry can be introduced between a penetrable/rupturable bottom plug and a solid top plug. Once placed, the cement slurry is allowed to harden to form the cement plug in the wellbore annulus, which prevents the flow of reservoir fluids between two or more permeable geologic formations that exist with unequal reservoir pressures.

Use of the spacer fluid as described herein provides a number of benefits. The fluids are stable at high wellbore temperatures, for example up to about 350° F., for example stable at about 150° F. to about 350° F., or about 150° F. to about 250° F. The spacer fluid is also compatible with both the non-aqueous drilling fluid and the cement slurries that they are used in conjunction with. Additionally, the spacer fluid can more effectively remove drilling muds and contaminant particles from wellbores, for example drilling fluid particulates, drilling cuttings, and particles of reservoir rock sloughed into the drilled wellbore from weak formations, for example a shale particulate, mudstone particulate, sandstone particulate, carbonate particulate, and the like. The spacer fluid can further suppress mixing of drilling fluids and cement slurries when compared to turbulent flow spacer fluids.

The method and composition further have the advantages of improved cementing, by reducing the amount of non-aqueous drilling fluids, contaminant particles, and other debris before introducing the cement slurry.

The beneficial effects of using the spacer fluid are further illustrated in the following examples.

### EXAMPLE

The baseline spacer fluid was formulated with 1.2 ppb of gelling agent, 273.5 ppb of weighting agent and 2 gpb of surfactants.

The spacer fluid according to the disclosure was formulated with 1.2 ppb of gelling agent, 273.5 ppb of weighting agent, 1 gpb of surfactant agent and 1 ppb of graphite nanoplatelets.

A rotor test was conducted on both the baseline spacer fluid and the spacer fluid according to the disclosure as follows. A non-aqueous drilling fluid was load into a rheology cup. The cup was placed on the base and raised up slowly until the drilling fluid was even with the line inscribed on the outer surface of a rotary sleeve. The rotary sleeve was rotated at 100 RPM for 5 minutes. The drilling fluid cup was removed, and any excess drilling fluid was allowed to drip from the sleeve. The base spacer fluid or the spacer fluid according to the disclosure was loaded into a clean rheology cup. The cup was placed on the base and raised up slowly until the spacer was even with the line inscribed on the outer surface of the rotary sleeve. The rotary sleeve was rotated at 100 RPM for 10 minutes. The cup was removed, and sleeve was visually observed, the cleanliness of the sleeve was recorded.

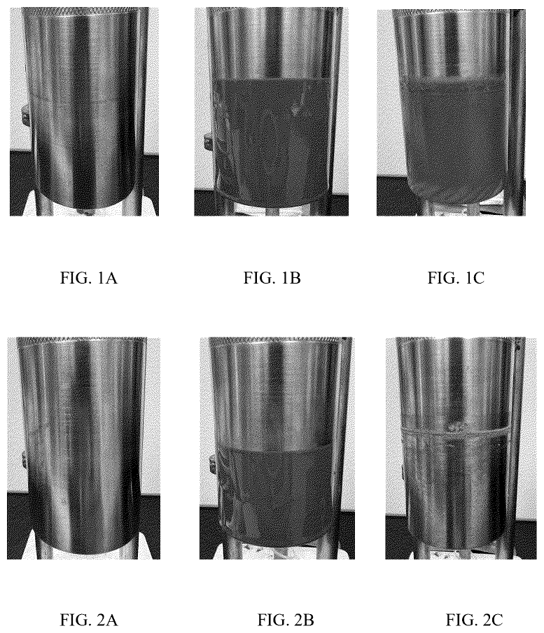

The results are shown in FIGS. 1A-1C for the baseline spacer fluid without graphite and FIGS. 2A-2C for the spacer fluid with graphite. The results show that when graphite is added to the baseline spacer fluid, the performance of the surfactants is greatly improved. Meanwhile, the amount of surfactants is also reduced by using the graphite.

Further included in this disclosure are the following specific methods and spacer fluids, which do not necessarily limit the claims.

Embodiment 1. A method comprising injecting a spacer fluid into a wellbore that comprises a non-aqueous drilling fluid, the spacer fluid comprising a liquid carrier and carbon particles comprising at least one of a graphite or graphene; and displacing the drilling fluid with the spacer fluid.

Embodiment 2. The method as in any prior embodiment, wherein displacing the drilling fluid further comprises displacing a contaminant particulate present in the wellbore.

Embodiment 3. The method of embodiment 2, wherein the contaminant particulate comprises at least one of a drilling fluid particulate, drilling cutting, or a reservoir rock particulate.

Embodiment 4. The method as in any prior embodiment, wherein a content of the carbon particles in the spacer fluid is about 0.05 pound per barrel to about 10 pounds per barrel.

Embodiment 5. The method as in any prior embodiment, wherein the carbon particles comprise at least one of graphite nanoplates, or graphene nanoplatelets.

Embodiment 6. The method as in any prior embodiment, wherein the spacer fluid further comprises at least one of a gelling agent, a weighting agent, and a surfactant.

Embodiment 7. The method of embodiment 6, wherein the spacer fluid comprises about 0.1 pound per barrel to about 5 pounds per barrel of the gelling agent, about 0 pound per barrel to about 600 pounds per barrel of the weighting agent, and about 0 gallon per barrel to about 10 gallons per barrel of the surfactant.

Embodiment 8. The method of embodiment 7, wherein the gelling agent comprises at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay.

Embodiment 9. The method of embodiment 6, wherein the spacer fluid comprises about 0.1 pound per barrel to about 5 pounds per barrel of the gelling agent, and about 50 pounds per barrel to about 600 pounds per barrel of the weighting agent.

Embodiment 10. The method of embodiment 9, wherein the weighting agent comprises at least one of barium sulfate, silica flour, fly ash, calcium carbonate, hematite, ilmenite, or siderite.

Embodiment 11. The method as in any prior embodiment, wherein the spacer fluid further comprises at least one of a gelling agent crosslinker, a pH control agent, a lubricant, a fluid loss agent, a clay stabilizer, a biocide, a corrosion inhibitor, a friction reducer, an oxygen scavenger, a formation fines controller, a foamer, a gel stabilizer, or a crosslinker.

Embodiment 12. The method as in any prior embodiment, wherein the spacer fluid comprises about 0.05 pound per barrel to about 10 pounds per barrel of graphite nanoplates, graphene nanoplatelets, or a combination thereof as carbon particles; about 0.1 pound per barrel to about 5 pounds per barrel of the gelling agent, the gelling agent comprising at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay; about 100 pounds per barrel to about 600 pounds per barrel of the weighting agent, the weighting agent comprising at least one of barium sulfate, silica flour, fly ash, calcium carbonate, hematite, ilmenite, or siderite; and about 0 gallon per barrel to about 10 gallons per barrel of the surfactant.

Embodiment 13. The method as in any prior embodiment, wherein the spacer fluid has a density that is higher than a density of the non-aqueous drilling fluid.

Embodiment 14. The method as in any prior embodiment, further comprising displacing the spacer fluid with a cement slurry.

Embodiment 15. The method as in any prior embodiment, wherein the wellbore has a bottom hole temperature of about 150° F. to about 350° F.

Embodiment 16. A spacer fluid comprising: an aqueous carrier; about 0.1 pound per barrel to about 10 pounds per barrel of graphite nanoplates, graphene nanoplatelets, or a combination thereof; about 0.1 pound per barrel to about 5 pounds per barrel of a gelling agent, the gelling agent comprising at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay; about 100 pounds per barrel to about 600 pounds per barrel of a weighting agent, the weighting agent comprising at least one of barium sulfate, silica flour, fly ash, calcium carbonate, hematite, ilmenite, or siderite, and about 0 gallon per barrel to about 10 gallons per barrel of a surfactant.

The thickness and width of the GNPs and graphene nanoplate can be determine using transmission electron microscopy (TEM), acute flaccid myelitis (AFM), X-ray diffraction (XRD) or scanning electron microscopy (SEM).

All ranges disclosed herein are inclusive of the endpoints, and the endpoints are independently combinable with each other (e.g., a range of “5 wt% to 20 wt%” is inclusive of the endpoints and all intermediate values of the ranges of “5 wt% to 25 wt%,” etc.). “Combinations” is inclusive of blends, mixtures, alloys, reaction products, and the like. “Or” means “and/or” unless clearly stated otherwise. The use of the terms “a” and “an” and “the” and similar referents in the context of describing the invention (especially in the context of the following claims) are to be construed to cover both the singular and the plural, unless otherwise indicated herein or clearly contradicted by context. The term “about” is intended to include the degree of error associated with measurement of the particular quantity based upon the equipment available at the time of filing the application. For example, “about” can include a range of ±8% of a given value.

Unless defined otherwise, technical and scientific terms used herein have the same meaning as is commonly understood by one of skill in the art to which this invention belongs.

While typical methods/downhole assemblies have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method comprising
injecting a spacer fluid into a wellbore that comprises a non-aqueous drilling fluid, the spacer fluid comprising a liquid carrier and carbon particles comprising at least one of a graphite or graphene, wherein graphite comprises graphite nanoplates (GNPs) having a thickness of greater than 0 nanometers (nm) to about 40 nm and graphene comprises graphene nanoplatelets having less than about 10 single sheet layers; and
displacing the drilling fluid with the spacer fluid.

2. The method of claim 1, wherein displacing the drilling fluid further comprises displacing a contaminant particulate present in the wellbore.

3. The method of claim 2, wherein the contaminant particulate comprises at least one of a drilling fluid particulate, drilling cutting, or a reservoir rock particulate.

4. The method of claim 1, wherein a content of the carbon particles in the spacer fluid is about 0.05 pound per barrel to about 10 pounds per barrel.

5. (canceled)

6. The method of claim 1, wherein the spacer fluid further comprises at least one of a gelling agent, a weighting agent, and a surfactant.

7. The method of claim 6, wherein the spacer fluid comprises 0.1 pound per barrel to 5 pounds per barrel of the gelling agent, 0 pound per barrel to 600 pounds per barrel of the weighting agent, and 0 gallon per barrel to 10 gallons per barrel of the surfactant.

8. The method of claim 7, wherein the gelling agent comprises at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay.

9. The method of claim 6, wherein the spacer fluid comprises about 0.1 pound per barrel to about 5 pounds per barrel of the gelling agent, and about 50 pounds per barrel to about 600 pounds per barrel of the weighting agent.

10. The method of claim 9, wherein the weighting agent comprises at least one of barium sulfate, silica flour, fly ash, calcium carbonate, hematite, ilmenite, or siderite.

11. The method of claim 1, wherein the spacer fluid further comprises at least one of a gelling agent crosslinker, a pH control agent, a lubricant, a fluid loss agent, a clay stabilizer, a biocide, a corrosion inhibitor, a friction reducer, an oxygen scavenger, a formation fines controller, a foamer, a gel stabilizer, or a crosslinker.

12. The method of claim 1, wherein the spacer fluid comprises
about 0.05 pound per barrel to about 10 pounds per barrel of graphite nanoplates, graphene nanoplatelets, or a combination thereof as carbon particles;
about 0.1 pound per barrel to about 5 pounds per barrel of the gelling agent, the gelling agent comprising at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay;
about 100 pounds per barrel to about 600 pounds per barrel of the weighting agent, the weighting agent comprising at least one of barium sulfate, silica flour, fly ash, calcium carbonate, hematite, ilmenite, or siderite; and
about 0 gallon per barrel to about 10 gallons per barrel of the surfactant.

13. The method of claim 1, wherein the spacer fluid has a density that is higher than a density of the non-aqueous drilling fluid.

14. The method of claim 1, further comprising displacing the spacer fluid with a cement slurry.

15. The method of claim 1, wherein the wellbore has a bottom hole temperature of about 150° F. to about 350° F.

16. A spacer fluid comprising:
an aqueous carrier;
0.1 pound per barrel to about 10 pounds per barrel of graphite nanoplates, graphene nanoplatelets, or a combination thereof;
0.1 pound per barrel to 5 pounds per barrel of a gelling agent, the gelling agent comprising at least one of a guar gum, a hydropropyl guar, a carboxymethyl guar, a carboxymethylhydroxypropyl guar, a hydratable polysaccharide, a xanthan gum, a galactomannan gum, a glucomannan gum, a cellulose, a hydroxyethylcellulose, a carboxymethylcellulose, a hydroxypropylcellulose, a carboxymethylhydroxyethylcellulose, a poly((meth)acrylic acid), a poly((meth)acrylamide), a copolymer of (meth)acrylic acid and (meth)acrylamide, a C1-8 alkyl poly(meth)acrylate, or a clay;
about 100 pounds per barrel to about 600 pounds per barrel of a weighting agent, the weighting agent comprising at least one of barium sulfate, silica flour, fly ash, calcium carbonate, hematite, ilmenite, or siderite, and
about 0 gallon per barrel to about 10 gallons per barrel of a surfactant.
